(19) United States
(12) Patent Application Publication
(10) Pub. No.: US 2025/0130918 A1
(43) Pub. Date: Apr. 24, 2025

(54) SYSTEMS AND METHODS FOR AUTOMATED GENERATION OF SYNTHETIC MODELLING DATA FROM AN INITIAL MODELLING DATASET

(71) Applicant: Capital One Services, LLC, McLean, VA (US)

(72) Inventors: Taylor TURNER, Richmond, VA (US); Jeremy GOODSITT, Champaign, IL (US); Michael DAVIS, Arlington, VA (US); Kenny BEAN, Herndon, VA (US); Tyler FARNAN, San Diego, CA (US)

(21) Appl. No.: 18/382,403

(22) Filed: Oct. 20, 2023

(51) Int. Cl. G06F 11/34

(52) U.S. Cl. CPC G06F 11/3447

(57) ABSTRACT

The present inventions is directed to systems and methods for automated stress testing of data models and comprises steps of generating, from an initial training dataset used for training a data model, a first data profile comprising a descriptive summary of the initial training dataset, generating a stress profile from an analysis of the data model and the initial training dataset used for training the data model, and modifying the first data profile by the stress profile to generate an altered data profile. A synthetic dataset may then be generated from the altered data profile. A stress performance output of the data model may then be used to identify weak points in the performance of the data model and improve the model's stress performance response using synthetic data.

### FIELD OF THE DISCLOSURE

The present disclosure relates to systems and methods for improving performance of data models, and more specifically to systems and methods for providing stress performance testing for data models.

### BACKGROUND

Customer behavior modeling is the creation of a mathematical model to represent the common behaviors observed among particular groups of customers in order to predict how similar customers will behave under similar circumstances. Models are typically based on mining of customer data, and each model can be designed to answer one or more questions at one or more particular periods in time. For example, a customer model can be used to predict how a particular group of customers may react in response to a particular marketing action. If the model is sound and the marketer follows the recommendations it generates, then the marketer will observe that a majority of the customers in the group respond as predicted by the model. Training data is used for training a model (e.g., data used to fit the model.) On the other hand, test data is used to evaluate the performance or accuracy of the model. It's a sample of data used to make an unbiased evaluation of the final model fit on the training data.

While behavior modeling is a beneficial tool, access to data can present a significant hurdle in training the model. In particular, models need large datasets in order to be properly trained. Only after a model is properly trained can the model be applied in practice. Data models are trained on datasets that include information regarding actual people. These datasets, generally referred to as original datasets, include real information about real people, including biographical, demographic, and even financial information about the people in the dataset. Much of this information can be sensitive information, and even though the data in the original dataset can be anonymized, the use of original datasets have significant privacy implications. In order to overcome the privacy concerns associated with original datasets, synthetic datasets can be used. Synthetic datasets can include computer generated customer information, which can then be used to train a model.

However, as synthetically generated model-training data is designed to reflect the data profile of a real dataset (which generally represents baseline or steady market states and conditions), there may be no assurance that a data model trained on synthetic data can produce reliable outcome in response to extreme and/or anomalous market conditions. Therefore, it may be beneficial to provide a system, method, and computer-accessible medium to effectively customize real and/or synthetically generated model-training data to reflect unprecedented market conditions for which real data samples may not be readily available.

### SUMMARY OF THE DISCLOSURE

In some aspects, the techniques described herein relate to a method for streamlined generation of synthetic data from a data profile, the method including: generating, from an initial training dataset used for training a data model, a first data profile, the first data profile including a descriptive summary of the initial training dataset; generating a stress profile from an analysis of the data model and the initial training dataset used for training the data model; modifying the first data profile by the stress profile to generated an altered data profile; generating a synthetic dataset from the altered data profile; and generating a stress performance output for the data model using the synthetic data.

In some aspects, the techniques described herein relate to a system for streamlined generation of synthetic data from a data profile, the system including a processor running a artificial intelligence (AI) engine and a memory, the memory containing instruction executed by the AI engine on an initial training data set used for training a data model, causes the process to: generate a first data profile for the initial training dataset, the first data profile including a descriptive summary of the initial training dataset; generate a stress profile from an analysis of the data model and the initial training dataset used for training the data model; alter the first data profile by the stress profile to generated an altered data profile; generate a synthetic dataset from the altered data profile; and generate a stress performance profile, for the data model, using the synthetic data.

In some aspects, the techniques described herein relate to a non-transitory computer-accessible medium including instructions for execution by a computer hardware arrangement, wherein, upon execution of the instructions the computer hardware arrange is configured to perform procedures including: generating, from an initial training dataset used for training a data model, a first data profile, the first data profile including a descriptive summary of the initial training dataset; generating a stress profile from an analysis of the data model and the initial training dataset used for training the data model; modifying the first data profile by the stress profile to generated an altered data profile; generating a synthetic dataset from the altered data profile; and generate a stress performance profile, for the data model, using the synthetic data.

### BRIEF DESCRIPTION OF THE DRAWINGS

Various embodiments of the present disclosure, together with further objects and advantages, may best be understood by reference to the following description taken in conjunction with the accompanying drawings.

FIG. 1 illustrates a synthetic generation of training datasets based on real datasets collected from a variety of sources in accordance with exemplary embodiments.

FIG. 2 illustrates an implementation for synthetic generation of stress training datasets in accordance with exemplary embodiments.

FIG. 3 illustrates an embodiment for incorporating stress handling features in the performance of a data model in accordance with exemplary embodiments.

FIG. 4 illustrates a process flow for generating synthetic stress-training datasets to optimize a model performance in response to stress and/or anomalous conditions in accordance with exemplary embodiments.

FIG. 5 is an illustration of a timing sequence diagram for stress training a data model in accordance with exemplary embodiments.

FIG. 6 is an illustration of a block diagram of an exemplary system in accordance with exemplary embodiments.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the exemplary embodiments may be practiced without one or more of the specific features or advantages of an exemplary embodiment. In other instances, additional features and advantages may be recognized in certain exemplary embodiments that may not be present in all exemplary embodiments. One skilled in the relevant art will understand that the described features, advantages, and characteristics of any exemplary embodiment can be interchangeably combined with the features, advantages, and characteristics of any other exemplary embodiment.

A dataset may corresponds to a collection of data that is treated as a single unit by a computer. This means that a dataset contains many separate pieces of data that can be used to train an algorithm with the goal of finding predictable patterns within the whole dataset. Training data is also known as a training dataset, learning set, and training set, and it is an essential component of every machine learning model and helps them make accurate predictions or perform a desired task. Simply put, training data builds the machine learning model. It teaches what the expected output looks like. The model analyzes the dataset repeatedly to deeply understand its characteristics and adjust itself for better performance. A training dataset is an initial dataset that teaches machine-learning (ML) models to identify desired patterns or perform a particular task. A testing dataset is used to evaluate how effective the training was or how accurate the model is.

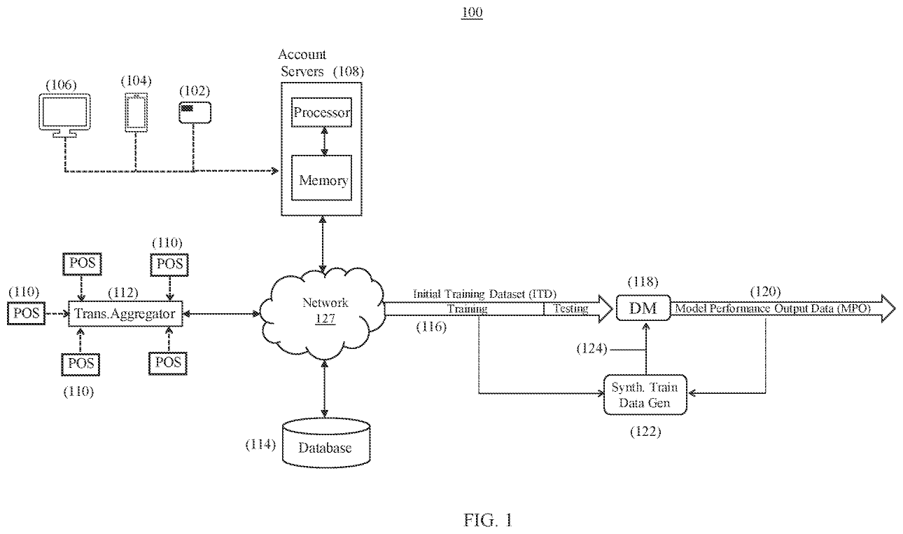

An important aspect moderating performance of a data model is the quality of the representative training data provided. The provisioning of high-quality input training data significantly enhances the accuracy of a data models' predictions. Model training datasets may include a testing portion containing unseen data points which are used to evaluate the model's accuracy. As shown in FIG. 1, model-training input datasets (e.g., initial training dataset 116) are generally divided into a training set and a testing set.

FIG. 1 illustrates an exemplary data mining and acquisition arrangement for generation of a real and/or original training dataset that may be used for training a data model. The real and/or original training datasets may further be used as input samples for generation of one or more synthetic training datasets. Synthetic datasets may be generated across large sample sizes which may be used to further hone the training process, and enhance the performance of a data model. The exemplary system implementation 100, in FIG. 1, illustrates a general overview of various components associated with a data mining process for obtaining real and/or original datasets for training data models. Such components may include user electronic devices used to conduct transactions (e.g., payment transaction cards 102, user mobile device 104 executing one or more payment applications, and a user computing device 106). Another source of data may include one or more financial servers 108 storing transactional records conducted, for example, by user devices 102-106. Financial server 108 may further store archives of transactional activities corresponding to a plurality of users and merchants.

The financial account server 108 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a smart card (e.g., a contactless card or a contact-based card), a kiosk, or any other network-enabled computing and/or communication device. The user device may include a processor, a memory, and one or more applications. The processor may include processing circuitry, which may contain additional components, including additional processors, memories, error and parity/CRC checkers, data encoders, anti-collision algorithms, controllers, command decoders, security primitives and tamper-proofing hardware, as necessary to perform its corresponding functions.

Referring back to FIG. 1, other exemplary sources of data correspond to transactional data generated by various merchant point of sale devices 110 that may be collected, for example, by one or more transaction aggregators 112, as well as data repositories (e.g., database 114) for retrieving, processing and archiving data related to users' electronic footprint and/or transaction activities. The data collected from various aforementioned sources may be acquired across a public and/or private network 127 and used as a training dataset for a data model (e.g., DM 118). Such model training datasets (e.g., initial training dataset 116) may then be used for training one or more data models 118. Various types of datasets may be used for training distinct aspects of a model response. Furthermore, different data models for predicting specific aspects of user and market response may be used. If the data model is sound, the output data 120 generated based on the performance of the data model 118, can be used to predict what a particular group of customers will do in response to a particular market condition.

However, as described, real dataset may be difficult to obtain and may further involve privacy concerns. Therefore synthetic datasets, generated from a sample real dataset, are often utilized for training data models. Synthetic dataset may correspond to a dataset generated from the same data profile characterizing an original/real dataset to ensure that the synthetically generated dataset reflects realistic conditions (e.g., in terms of actual user behavior to existing market conditions) represented by the real dataset. Therefore, synthetically generated datasets tend to have very similar statistical and summary characteristics as the original dataset from which they were generated. For example, referring back to example 100, the original/real training dataset 116 may be fed into a synthetic data generating process/module 122 to generate a plurality of synthetic training datasets 124 (representing a large quantity of training data) which realistically represent user behaviors associated with large groups of hypothetical users. In some embodiments, the synthetic training datasets 124 may comprise one or more data values that lie outside the bounds of the original and/or real training dataset 116.

However, as described above synthetically generated model-training data is designed to reflect the data profile of a real dataset (which generally represents baseline or steady market states and/or conditions.) Therefore the model training process may not render a data model responsive to extreme and/or anomalous market conditions, as training datasets (real or synthetic) are not customized to reflect unprecedented market conditions with no readily available real data samples. Arbitrary assignment of extreme data values to parameters of a training dataset may corrupt a data profile causing the model performance to deviate from a realistic response, and furthermore may introduce user errors into the model training process, and by extension, the model performance. Considering recent pandemic-related extended lockdown conditions and their impact on the global market, an effective process for stress-related synthetic customization of model-training datasets (capable of reflecting unprecedented market conditions with no readily available real data samples) may be of significant value. As such, some embodiments of the present disclosure are directed to streamlining the process for automated generation of synthetic training datasets geared toward anomalous market conditions (e.g., market conditions not generally reflected in real training datasets and/or synthetics training datasets generated based on real dataset profiles.) Such synthetic training datasets, geared towards training a stress response with respect to a data model, may comprise one or more data values that are outside the bounds of synthetic data ranges directly generated from a real dataset profile. Embodiments of the present disclosure are directed towards systems and methods for generation of synthetic stress training datasets in a ubiquitous manner applicable to any data model irrespective of the specific purpose and attribute under study. Such synthetically generated datasets may then be used to effectively train a versatile stress response in data models.

One aspect of the proposed solution is based on extraction of a data profile from a model training dataset. A stress-related data profile may then be superimposed on the statistical parameters associated with the extracted data profile to artificially create aberrations/alteration, representative of extreme and/or abnormal market and/or socioeconomic scenarios, in the extracted data profile. A synthetic model-training dataset, generated based on the aforementioned altered data profile, may then be used for training a data model to ensure its reliable performance under a variety of extreme market conditions.

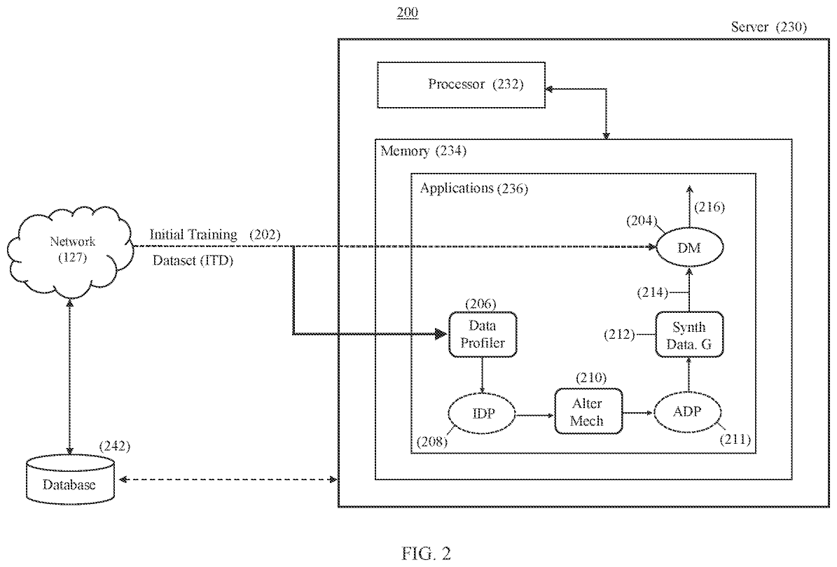

FIG. 2 illustrates a system implementation for automatically generating an altered model-training dataset geared towards realistic representation of various extreme market conditions. In some embodiments, data profile perturbations (for representing anomalies and stress conditions) may comprise major distribution shift testing and/or pushing variables (e.g., data parameters) with low and high importance to their distributional limits to artificially create extreme aberrations without corrupting the dataset. Such alterations in the data profile of an initial training dataset facilitates an examination of a data model's stress landscape in a simple, repeatable and easily reproducible way using realistic but synthetically generated data.

Referring back to example 200, in FIG. 2, an initial training dataset 202 may correspond to a real/original dataset and/or a synthetically generated dataset designed based on a data profile of corresponding real dataset. In some examples, dataset 202 may correspond to a task-specific dataset operative to train the data model 204 for a specific task. In accordance with the exemplary implementation 200, the initial training dataset 202, used for example to train data model 204, may be applied to a data profile extraction process (e.g., data profiler 206). The data profiler 206 computes a data profile, represented as the initial data profile (IDP) 208, for the initial training dataset 202. The computed data profile represents a description of the data in the dataset in terms of its main parameters types and categories, general statistical characteristics associated with the various data parameters, value ranges for specific data parameters, distributional attributes of various parameter values, and other various features and patterns in the dataset as a whole.

The computed initial data profile 208 then undergoes a profile alteration mechanism 210 which may identify various relevant data parameters and statistical attributes corresponding to the initial training data 202, and introduce deviations that pushes the various data profile parameter values (e.g., observed minimum, maximum, and/or average values) to the distributional limits, in order to generate an altered data profile (ADP) 211. According to some examples, various distinct alteration mechanisms may be designed to introduce a set of task-specific profile deviations representative of different extreme/anomalous conditions into the initial data profile data 208. In such scenarios, the resulting ADP 211 may represent a stress profile for a specific phenomenon and/or task.

The altered data profile 211 (e.g., representing one or more stress conditions) may be applied to a synthetic data generator 212 for generating a stress-training dataset 214 for training a stress response associated with the data model 204. The performance output of the data model 204 may then be trained using a training data portion of the stress-training dataset 214 and various iterations thereof, until the stress performance output 216 matches the testing data portion of the stress-training dataset 214. Multiple iterations of the stress training dataset 214 may be synthetically generated until a reliable stress performance output is observed. In some embodiment stress performance output 216 may also be used in a feedback arrangement for computing a set of distinct alteration profiles meant to explore the performance limits of the data model 204.

In some embodiments, the initial data profile (corresponding to the initial model training dataset) may be computed on a real and/or original dataset. The process may then be followed by the identification of relevant perturbations and generation of synthetic data necessary to stress test the model. The synthetically generated stress-training datasets may subsequently be used to perform the stress test and evaluate a corresponding stress response of the data model. In some embodiments the initial training data 202 may correspond to synthetically generated training data 124 (illustrated in FIG. 1). In such instances the initial data profile would correspond to a data profile of the synthetically generated dataset which may be representative of a data profile associated with a corresponding real training dataset.

In some cases, multiple aspects of a data model may require distinct sets of training data. In some examples, a data model may correspond to a multitude of profiles for testing various aspects of a model's performance under stress. As such, some data models may be associated with multiple stress profiles from which multiple sets of synthetic training data, for training various distinct performance aspects of a data model, may be generated. Stress profiles may also be generated for training a plurality of distinct data models associated with distinct sets of initial training datasets. In some embodiments the stress-based perturbations may be applied to a selected set of data profile parameters corresponding to a set of relevant model characteristics under examination.

As described earlier, anomaly stress training may be characterized in terms of varying and extending statical ranges and distributional characteristics extracted from a data profile of an input training dataset. In some embodiments, anomaly stress testing may further utilize information regarding a stress performance output of a data model in a feedback loop for optimizing the alteration mechanisms (e.g., to improve the efficacy of a stress training dataset). In other embodiments, one or more outlying input data values (in the initial training dataset) and/or output data values (in the model's output response) may be identified based on analysis of the distributional and statistical characteristics associated with a model's performance output in correlation with the initial training dataset. A stress profile may then incorporate one or more subsets and/or various iterations of the identified outlying data values. A stress training dataset representing various ranges of such outlier data values may then be generated, by the synthetic data generator, based on the stress profile.

In some embodiment alteration mechanisms may comprise more than an application of perturbations to the parameter values associated with a data profile of a training dataset. For example, alteration mechanisms for stressing a data model may correspond to direct injection of training data values associated with missing and/or out of range and error-indicating data values (e.g., missing credit score being assigned a numeric value of −999). In such cases an altered profile may incorporate one or more missing data values and/or values outside of the norm to determine a model's response to such attributes in the input training dataset. Such synthetically generated stress training datasets, as described in accordance to the embodiments of the present disclosure, may also be used on data models under development and may be geared towards ensuring that the data model satisfies relevant risk factors.

Referring back to FIG. 2, one or more data models, data profiler, data profile alteration mechanisms, and synthetic data generator may be stored on server 230 which may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a smart card (e.g., a contactless card or a contact-based card), a kiosk, or any other network-enabled computing and/or communication device. The user device may include a processor, a memory, and one or more applications that may perform the functions described herein. The processor may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The server 230 may include a processor 232, a memory 234, and one or more applications 236 that may perform the functions described herein. The one or more processes and computing modules (e.g., 204-212) may be running in context or as part of the one or more applications 236. The processor 232 may be a processor, a microprocessor, or other processor, and the server 230 may include one or more of these processors. The processor 232 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The server 230 may be communicatively coupled (e.g., via a direct connection 240 and/or network 127) to a database 242 which may be configured to store data model, including without limitation, one or more initial training datasets, one or more task-specific altered data profiles and/or model performance histories corresponding to various initial training and/or stress-related datasets. The database 242 may comprise a relational database, a non-relational database, or other database implementations, and any combination thereof, including a plurality of relational databases and non-relational databases. In some examples, the database 242 may comprise a desktop database, a mobile database, or an in-memory database. Further, the database 242 may be hosted internally by the server 240 or may be hosted externally and communicatively coupled with the server 240.

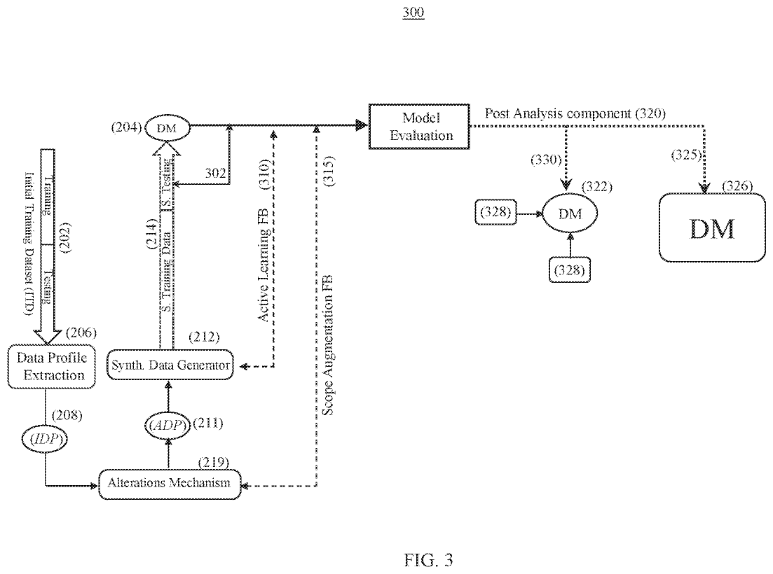

FIG. 3 illustrates an exemplary operational overview 300 for implementing and/or training a stress performance feature in a data model. In the example 300, similar features corresponding to the generation of synthetic stress training dataset, as illustrated in FIG. 2, are referenced with similar notations. As illustrated in FIG. 3, a first level for evaluating a stress performance output of a data model may involve matching the model's performance output against the testing portion of the synthetic stress dataset as shown by the feedback interaction 302. Other embodiments may involve an active learning scheme based on probing the data model to identify weak and/or under-developed performance features, using the synthetic data. This may involve testing a data model's stress performance output against various iterations of the stress training dataset as shown by the feedback interaction 310, to supplement the training for certain aspects of the data model that may require additional training data.

Other embodiments may involve a feature for augmenting the performance of a data model (e.g., augmenting training scope of a data model) to encompass various stress conditions, using synthetic data. This may involve testing a models' stress performance output against various task-specific stress profiles as shown by the feedback interaction 315. Further embodiments may involve an analysis of a data model profile, in combination with a corresponding initial data profile (e.g., data profile of an initial training dataset) to identify one or more weak points associated with the performance of the data model. The analysis, in accordance with some embodiments, may be based on explainability (e.g., evaluation by a user) for identification of data values for which the data model does not produce a meaningful outcome. The information, regarding the identified weak points may then be used, by the alteration mechanism 219 (e.g. via feedback interaction 315) to optimally identify a stress profile that could be applied to the initial data profile to expand the training scope of the data model.

The exemplary implementation 300, further illustrates a model evaluation process/module 320 for post analysis of the models' stress performance output 320 to identify weak points in the data models' performance. The post analysis of the stress performance output 320 may further involve a feature for enhancing the performance scope of the model by altering a data model algorithm and/or computational expressions to encompass a stress response (e.g., as shown by path 325 and augmented data model 326). Other embodiments may involve a feature for enhancing the performance scope of the model by altering a model with one or more computation components 328 that may be initiated in response to a detection of one or more data ranges within a stress threshold (e.g., as shown by path 330 and augmented data model 332).

In some embodiments, the stress performance output of a data model may be operative to generate an error and/or risk report that provides a risk review on the data model. The risk review may comprise a performance report of the data model under a set of extreme conditions represented by a corresponding synthetic stress datasets (e.g., associated with distinctly altered profiles). The stress report may provide a summary output on various performance aspects of a data model within one or more identified data ranges. This may further improve the task of identifying one or more weak points in the performance of the model, as well as a corresponding set of model computational adjustments (e.g., 325 and/or 330) and/or additional sets of synthetic stress training datasets required for addressing the identified weak points in the performance of the model.

In some embodiments, a history of previous stress training datasets and stress performance outputs, associated with various data models, may be analyzed to determine a plurality of perturbations and alteration features that have been effective in exposing weak points in the performance output of various data models.

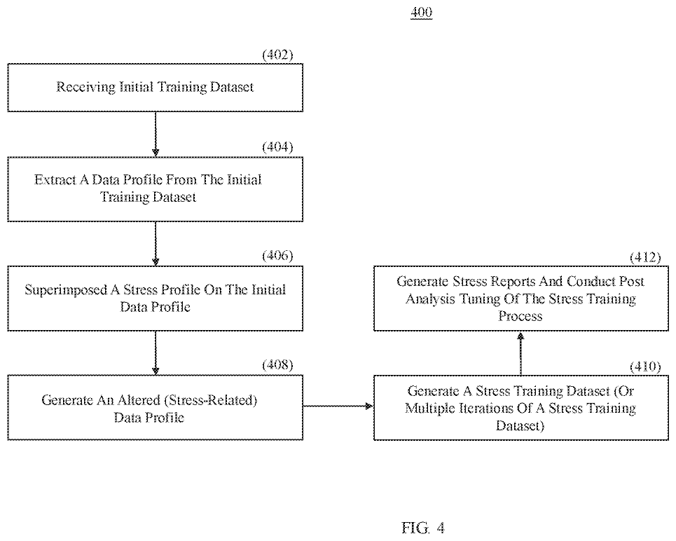

FIG. 4 illustrates an exemplary process flow 400 for synthetic generation of stress testing datasets for data models. With reference to the exemplary process flow 400, at step 402, one or more initial training datasets are received by the system on which a data profiler process is executing. The initial training datasets may correspond to real and/or original datasets retrieved for example through data mining operations and data acquisition arrangement illustrated, for example, in FIG. 1. The one or more initial datasets are passed down to the data profiler, and at step 404 a data profile is extracted from the received initial training datasets (e.g., corresponding to the one or more datasets received at step 402.) In some embodiments, if the one or more initial training datasets are associated with the same task and/or training objective, then the data profile may be extracted by analyzing the entirety of the one or more initial training datasets. However, if each incoming dataset is task-specific designed for training the data model for a specific task, then a distinct data profile may be computed for, and/or extracted from, each of the one or more datasets.

At step 406 a stress profile may be superimposed on the initial data profile extracted from the initial dataset(s). The stress profile may correspond to identification of a set of target statistical parameters associated with the dataset and alterations/perturbations of the target statistical parameters. The magnitude and polarity of the perturbations (e.g., an increase or a decrease in value) may correspond to one or more stress conditions for which a data model is being trained. In some embodiments, the perturbations, applied to the data profile in step 406, may involve pushing the data values for one or more statistical parameters, associated with the computed data profile (e.g., step 404), to their distributional extremes. Based on the applied perturbations, an altered (stress-related) data profile is generated by the data profiler at step 408. In some embodiments, the altered data profile may be generated by a distinct process and/or a computation module communicatively coupled with the data profiler. In some examples, the data profile alteration mechanisms may be integrated in or modularly applied to the data profiler.

Using the altered data profile, a stress training dataset (or multiple iterations of a stress training dataset) is generated at step 410. The stress training dataset enables a more enhanced and thorough stress training of the data model. In some embodiments, multiple stress training datasets based on distinct perturbation profiles may be generated reflecting one or more distinct anomalous scenarios. At step 412, the stress performance output of the data model may be used to generate a stress report which identifies weak points in the predictive performance of the data models. In some embodiments, the stress performance output of the data model may further be used in a feedback configuration to fine-tune the alteration mechanisms and/or generate additional stress training datasets in order to optimize a stress response of the data model. The post analysis operations, as shown in step 412, may involve an identification of stress characteristics that may require additional training with subsequent (e.g., synthetically generated) iterations of the stress training dataset. In such a scenario, a call is made to the data profiler for additional data samples to be generated (e.g., at step 410) from the stress profile (e.g., altered data profile) created at step 408. In some embodiments, the post analysis step may further involve an identification of various aspects of the models' stress performance that may require additional training with different stress profiles (e.g., augmentation of the models' output stress response profile). In such cases, a call may be made to the data profiler for generations of a relevant stress profile to be superimposed on the initial data profile at step 406, resulting in the generation of a distinct altered data profile at step 408.

Accordingly, one aspect of the present invention is directed to a method for streamlined generation of synthetic data from a data profile. The method comprises a step of generating, from an initial training dataset used for training a data model, a first data profile, the first data profile comprising a descriptive summary of the initial training dataset. The method may further comprise a step of generating a stress profile from an analysis of the data model and the initial training dataset used for training the data model; and modifying the first data profile by the stress profile to generate an altered data profile. The method may include a step of generating a synthetic dataset from the altered data profile; and generating a stress performance output for the data model using the synthetic data. In some embodiments a data distillation process may be applied to multiple sets of stress training datasets based on distinct stress profiles to identify an optimal data set to maximize the quality of training and the amount of training data required to simulate one or more specific stress conditions.

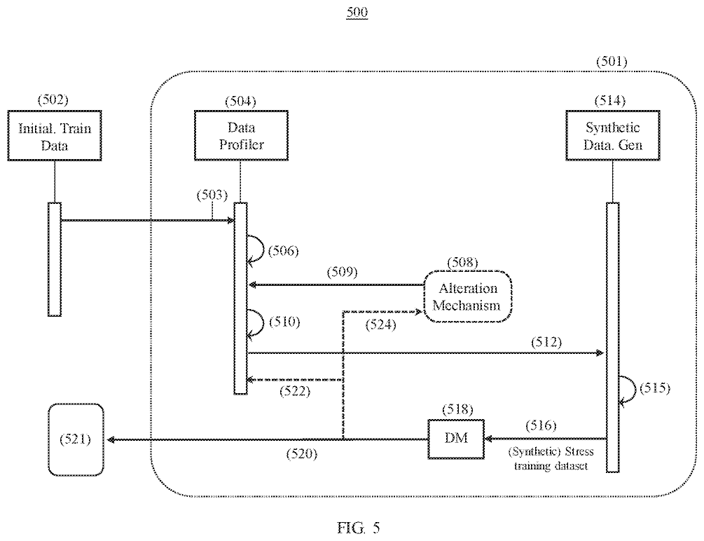

FIG. 5 illustrates an exemplary timing sequence flow 500 for operation of a data profiler module/process integrated with a stress training functionality. The data profiler module/process may be executed as a part of an artificial intelligent (AI) system 501. With reference to example 500, a data profiler process 504 may receive one or more sets of initial model training data 502. The initial training dataset(s) may be used for training and testing a data model. The initial training dataset may correspond to original data, and/or synthetically generated training data designed to reflect a data profile of real and/or original dataset. At step 506 the data profiler computes a data profile associated with the initial training dataset 502. A data profile alteration routine (e.g., alteration mechanism 508) may be initiated by the data profiler 504 in order to generate a stress profile to be superimposed on the initial data profile extracted from the initial datasets. The alternation mechanism (e.g., functionality for generating a stress profile) may be integrated in the data profiler or modularly applied to the data profiler. In some embodiments, the data profiler may correspond to an open source data profiler process.

The stress profile generation may correspond to identification of a set of target statistical parameters associated with the dataset and alterations and/or perturbations of the target statistical parameters. The magnitude and polarity of the perturbations (e.g., an increase or a decrease in value) may correspond to one or more stress conditions and/or requirements for which a data model is being trained. In some embodiments, the perturbations, applied to the data profile computed at 506, may involve pushing the data values, for one or more statistical parameters and/or descriptive variables associated with the computed data profile, to their distributional extremes. Training may be task specific or it may be directed to one or more general aspects of a data models' performance. The alteration mechanisms 508, amounting to a stress-related data profile, may be generated by one or more computational components of the data profiler 504 or by a separate computational component of the AI system, communicatively coupled to the data profiler 504.

The stress data profile 509, generated based on alteration mechanisms 508 applied to the initial data profile, is passed onto the data profiler. Based on the applied perturbations, an altered (e.g., stress-related) data profile is generated by the data profiler at 510. The altered data profile 512 is provided to a synthetic data generator 514. The synthetic data generator 514 may generate one or more iterations of the stress training dataset at 515. In some embodiments, the synthetic data generator 514 may correspond to a computational component integrated within the data profiler 504, in which case the synthetic data generation operation 515 may be carried out by the data profiler 504. In some embodiments, the synthetic data generator 514 and the synthetic data generation operation 515 may be carried out by a distinct computational component of the AI system, communicatively coupled to the data profiler 504. The synthetic stress training dataset 516 may then be fed into a data model 518 for training a stress response into the data model. Some embodiments may involve a modular application of the stress profile (e.g., an alteration mechanism) to a data profiler module. In some embodiments, the data profiler module may execute an open source data profiler process.

In some embodiments, the stress performance output 520 of the data model 518 may be further used in a feedback configuration to fine-tune the alteration mechanisms and/or generate additional stress training datasets in order to enhance and optimize a stress response of the data model. The post analysis process, as shown by operation 522, may involve an identification of stress characteristics that may require additional training with subsequent (e.g., synthetically generated) iterations of the stress training dataset. In such a scenario a call may be made to the data profiler for additional data samples to be generated from the stress profile generated at 510. In some embodiments, the post analysis process, as shown by operation 524, may further involve an identification of various aspects of the models' stress performance that may require additional training with different stress profiles (e.g., augmentation of the models' outputs stress response profile) in which case a call may be made for invocation of one or more relevant stress profiles to be superimposed on the data profile at 510, resulting in the generation of a distinct altered data profile at 512. A stress-related performance summary report 521 may be generated based on an analysis of the stress performance output 520 associated with data model 518. In some embodiments the stress performance output 520 may be analyzed in conjunction with the stress data profile 512 and the standard performance output of the model as trained by the initial training data 502.

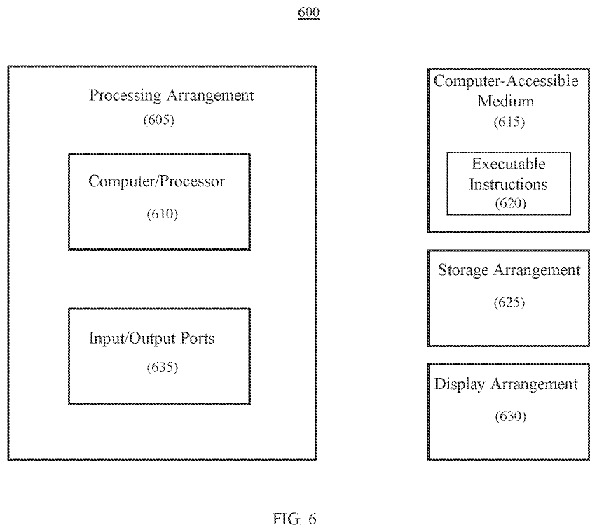

FIG. 6 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 605). Such a processing and/or computing arrangement 605 can be, for example entirely or a part of, or include, but not limited to, a computer and/or processor 610 that can include, for example one or more microprocessors, and use instructions stored on a computer-accessible medium (e.g., RAM, ROM, hard drive, or other storage device).

As shown in FIG. 6, for example a computer-accessible medium 615 (e.g., as described herein may comprise, a storage device such as a hard disk, floppy disk, memory stick, CD-ROM, RAM, ROM, etc., or a collection thereof) can be provided (e.g., in communication with the processing arrangement 605) The computer-accessible medium 615 can contain one or more executable instructions 620 stored thereon. In addition or alternatively, a storage arrangement 625 can be provided separately from the computer-accessible medium 615, which can provide the instructions to the processing arrangement 605 so as to configure the processing arrangement to execute certain exemplary procedures, processes, and methods, as described herein above, for example.

Further, the exemplary processing arrangement 605 can be provided with or include an input/output ports 635, which can include, for example a wired network, a wireless network, the internet, an intranet, a data collection probe, a sensor, etc. As shown in FIG. 6, the exemplary processing arrangement 605 can be in communication with an exemplary display arrangement 630, which, according to certain exemplary embodiments of the present disclosure, can be a touch-screen configured for inputting information to the processing arrangement in addition to outputting information from the processing arrangement, for example. Further, the exemplary display arrangement 630 and/or a storage arrangement 625 can be used to display and/or store data in a user-accessible format and/or user-readable format.

In some aspects, the techniques described herein relate to a method for streamlined generation of synthetic data from a data profile, the method including: generating, from an initial training dataset used for training a data model, a first data profile, the first data profile including a descriptive summary of the initial training dataset; generating a stress profile from an analysis of the data model and the initial training dataset used for training the data model; modifying the first data profile by the stress profile to generated an altered data profile; generating a synthetic dataset from the altered data profile; and generating a stress performance output for the data model using the synthetic data.

In some aspects, the techniques described herein relate to a method, wherein the synthetic dataset is used for stress testing the data model.

In some aspects, the techniques described herein relate to a method, wherein the synthetic data, generated from the altered data profile, includes one or more first data values outside the bounds of the first data profile associated with the initial training dataset.

In some aspects, the techniques described herein relate to a method, wherein the one or more first data value corresponds to data values for which the data model does not produce a meaningful outcome.

In some aspects, the techniques described herein relate to a method, further including: identifying a data range from the altered data profile that includes the one or more first data values, and generating one or more second data values within the data range for evaluating a performance of the data model.

In some aspects, the techniques described herein relate to a method, wherein the first data profile is generated by processing a plurality of data with an open source data profiler process.

In some aspects, the techniques described herein relate to a method, wherein the stress profile is determined based on one or more identified weak points associated with a performance of the data model.

In some aspects, the techniques described herein relate to a method, wherein the one or more identified weak points are identified based on characterizing the performance of the data model based on the first data profile.

In some aspects, the techniques described herein relate to a method, further including distilling the initial training dataset into a reduced corpus of dataset that has the same impactful information as the initial training dataset.

In some aspects, the techniques described herein relate to a system for streamlined generation of synthetic data from a data profile, the system including a processor running a AI engine and a memory, the memory containing instruction executed by the AI engine on an initial training data set used for training a data model, causes the process to: generate a first data profile for the initial training dataset, the first data profile including a descriptive summary of the initial training dataset; generate a stress profile from an analysis of the data model and the initial training dataset used for training the data model; alter the first data profile by the stress profile to generated an altered data profile; generate a synthetic dataset from the altered data profile; and generate a stress performance profile, for the data model, using the synthetic data.

In some aspects, the techniques described herein relate to a system, wherein the synthetic dataset is used for stress testing the data model.

In some aspects, the techniques described herein relate to a system, wherein the synthetic dataset, generated from the altered data profile, includes one or more first data values outside the bounds of the first data profile associated with the initial training dataset.

In some aspects, the techniques described herein relate to a system, wherein the one or more first data value corresponds to data values for which the data model does not produce a meaningful outcome

In some aspects, the techniques described herein relate to a system, further including instruction to: identify a data range from the altered data profile that includes the one or more first data values, and generate one or more second data values within the data range to evaluate a performance of the data model,

In some aspects, the techniques described herein relate to a system, wherein the processor is configured to generate the first data profile by processing a plurality of data in the initial training dataset with an open source data profiler process.

In some aspects, the techniques described herein relate to a system, wherein the processor is configured to compute the stress profile based on one or more identified weak points associated with a performance of the data model.

In some aspects, the techniques described herein relate to a method, wherein the one or more identified weak points are identified based on characterizing the performance of the data model in response to the first data profile.

In some aspects, the techniques described herein relate to a non-transitory computer-accessible medium including instructions for execution by a computer hardware arrangement, wherein, upon execution of the instructions the computer hardware arrange is configured to perform procedures including: generating, from an initial training dataset used for training a data model, a first data profile, the first data profile including a descriptive summary of the initial training dataset; generating a stress profile from an analysis of the data model and the initial training dataset used for training the data model; modifying the first data profile by the stress profile to generated an altered data profile; generating a synthetic dataset from the altered data profile; and generate a stress performance profile, for the data model, using the synthetic data.

In some aspects, the techniques described herein relate to a non-transitory computer-accessible medium, further including instructions for stress testing the data model the synthetic dataset.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

A computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for streamlined generation of synthetic data from a data profile, the method comprising:
generating, from an initial training dataset used for training a data model, a first data profile, the first data profile comprising a descriptive summary of the initial training dataset;
generating a stress profile from an analysis of the data model and the initial training dataset used for training the data model;
modifying the first data profile by the stress profile to generated an altered data profile;
generating a synthetic dataset from the altered data profile; and
generating a stress performance output for the data model using the synthetic data.

2. The method of claim 1, wherein the synthetic dataset is used for stress testing the data model.

3. The method of claim 1, wherein the synthetic data, generated from the altered data profile, comprises one or more first data values outside a bounds of the first data profile associated with the initial training dataset.

4. The method of claim 3, wherein the one or more first data value corresponds to data values for which the data model does not produce a meaningful outcome.

5. The method of claim 3, further comprising: identifying a data range from the altered data profile that comprises the one or more first data values, and generating one or more second data values within the data range for evaluating a performance of the data model.

6. The method of claim 1, wherein the first data profile is generated by processing a plurality of data with an open source data profiler process.

7. The method of claim 1, wherein the stress profile is determined based on one or more identified weak points associated with a performance of the data model.

8. The method of claim 7, wherein the one or more identified weak points are identified based on characterizing the performance of the data model based on the first data profile.

9. The method of claim 1, further comprising distilling the initial training dataset into a reduced corpus of dataset that has a same impactful information as the initial training dataset.

10. The method of claim 1, wherein a data distillation process is applied to a plurality of stress training datasets, generated based on distinct stress profiles, to identify to maximize a quality of one or more training datasets required to simulate one or more specific stress conditions.

11. A system for streamlined generation of synthetic data from a data profile, the system comprising a processor executing an artificial intelligence (AI) engine and a memory, the memory containing instructions executed by the AI engine on an initial training data set used for training a data model, wherein when executed by the AI engine, the instructions cause the processor to:
generate a first data profile for an initial training dataset, the first data profile comprising a descriptive summary of the initial training dataset;
generate a stress profile from an analysis of the data model and the initial training dataset used for training the data model;
alter the first data profile by the stress profile to generated an altered data profile;
generate a synthetic dataset from the altered data profile; and
generate a stress performance profile, for the data model, using the synthetic data.

12. The system of claim 11, wherein the synthetic dataset is used for stress testing the data model.

13. The system of claim 11, wherein the synthetic dataset, generated from the altered data profile, comprises one or more first data values outside a bounds of the first data profile associated with the initial training dataset.

14. The system of claim 13, wherein the one or more first data values correspond to data values for which the data model does not produce a meaningful outcome.

15. The system of claim 14, further causing the processor to:
identify a data range from the altered data profile that comprises the one or more first data values; and
generate one or more second data values within the data range to evaluate a performance of the data model.

16. The system of claim 11, wherein the processor is configured to generate the first data profile by processing a plurality of data in the initial training dataset with an open source data profiler process.

17. The system of claim 11, wherein the processor is configured to compute the stress profile based on one or more identified weak points associated with a performance of the data model.

18. The system of claim 17, wherein the one or more identified weak points are identified based on characterizing the performance of the data model in response to the first data profile.

19. A non-transitory computer-accessible medium comprising instructions for execution by a computer hardware arrangement, wherein, upon execution of the instructions the computer hardware arrangement performs procedures comprising:
generating, from an initial training dataset used for training a data model, a first data profile, the first data profile comprising a descriptive summary of the initial training dataset;
generating a stress profile from an analysis of the data model and the initial training dataset used for training the data model;
modifying the first data profile by the stress profile to generated an altered data profile;
generating a synthetic dataset from the altered data profile; and
generating a stress performance profile, for the data model, using the synthetic data.

20. The non-transitory computer-accessible medium of claim 19, further comprising instructions for stress testing the data model the synthetic dataset.
